(19) United States
(12) Patent Application Publication
(10) Pub. No.: US 2026/0111782 A1
(43) Pub. Date: Apr. 23, 2026

(54) A METHOD FOR OPTIMIZING A QUANTUM OPERATION TO BE APPLIED ON TWO QUANTUM OBJECTS OF A SYSTEM OF QUANTUM OBJECTS

(71) Applicants: Université de Strasbourg, STRASBOURG (FR); Centre national de la recherche scientifique, PARIS (FR); The Trustees of Princeton University, Princeton, NJ (US)

(72) Inventors: Guido PUPILLO, STRASBOURG (FR); Sven JANDURA, STRASBOURG (FR); Jeffrey THOMPSON, PRINCETON, NJ (US)

(21) Appl. No.: 19/116,983

(22) PCT Filed: Sep. 28, 2023
(86) PCT No.: PCT/EP2023/076964

§ 371 Date: Mar. 28, 2025

(30) Foreign Application Priority Data
Sep. 30, 2022 (EP) 22306463.5

(51) Int. Cl. G06N 10/40; G06N 10/20

(52) U.S. Cl. CPC G06N 10/40; G06N 10/20

(57) ABSTRACT

A method for optimizing a quantum operation to be applied on at least two quantum objects of a system of quantum objects, the method including the determination of an optimized pulse to be generated by at least one controlled laser for implementing the quantum operation on the at least two quantum objects while fulfilling a robustness criterion, the at least two quantum objects having a quantum state depending on the excitation level of the at least two quantum objects, the excitation level being chosen between 01, 10 and 11, 0 defining a de-excited state for a quantum object and 1 defining an excited state for a quantum object, the quantum state having a zero order term and a first order term.

### TECHNICAL FIELD OF THE INVENTION

The present invention concerns methods for optimizing a quantum operation to be applied on two quantum objects of a system of quantum objects. The present invention also concerns devices for optimizing a quantum operation to be applied on two quantum objects of a system of quantum objects.

### BACKGROUND OF THE INVENTION

Rydberg atoms have become a promising candidate to realize quantum computations and quantum simulations. In this platform, alkali, alkaline-earth or alkaline-earth-like atoms are trapped in arrays of optical tweezers and cooled to sub-milikelvin temperatures. Each atom serves as a qubit, with the computational subspace spanned by two stable or metastable states. Two-qubit gates can be implemented by using a laser to excite the atoms to auxiliary Rydberg states, which interact via the strong and long ranged van der Waals interaction. Recently, several implementations of a controlled-Z (CZ) gate using a global laser pulse, which illuminates both atoms and does not require individual addressing, have been proposed.

However, like all quantum computation platforms, calculations on Rydberg atoms currently suffer from imperfections, which prevent the execution on long quantum circuits. Relevant error sources include the finite lifetime of the Rydberg state, imperfections of the laser pulse perceived by the atoms, and the dependency of the interactions strengths of the atoms on the position of the atoms, which fluctuates in the trap. The imperfections of the laser pulse can be grouped into two categories: intensity and frequency noise inherent to the laser, and imperfections related to the uncertain atomic positions and velocities. The latter category consists of errors induced by the Doppler shift due to the thermal motion of the atoms, as well as the uncertainty of the laser intensity if it is not spatially homogeneous.

### SUMMARY OF THE INVENTION

There is therefore a need for a method enabling to reduce the errors affecting a two qubits quantum operation.

To this end, the invention relates to a method for optimizing a quantum operation to be applied on at least two quantum objects of a system of quantum objects, the method comprising the determination of an optimized pulse to be generated by at least one controlled laser for implementing the quantum operation on the at least two quantum objects while fulfilling an amplitude robustness criterion, the at least two quantum objects having a quantum state depending on the excitation level of the at least two quantum objects, the excitation level being chosen between 01, 10 and 11, 0 defining a de-excited state for a quantum object and 1 defining an excited state for a quantum object, the quantum state having a zero order term and a first order term, the amplitude robustness criterion stating that the optimized pulse is a pulse which when applied on the at least two quantum objects is such that:
the zero order term is substantially of the form e^{iθ}^{_{q}}|q [symbol] , with θ₁₁−θ₁₀−θ₀₁=(2n+1)π, n being an integer,
the first order term is substantially equal to zero,
the optimized pulse being intended to be generated by the at least one controlled laser and applied on the at least two quantum objects so as to realize the quantum operation.

The method may comprise one or more of the following features considered alone or in any combination that is technically possible:
the amplitude robustness criterion states that the optimized pulse is a pulse which minimizes a cost function, the cost function being the sum of a first cost term depending on the zero order term of the quantum state and of a second cost term (J₂) depending on the first order term of the quantum state;
the cost function (J) is given by the following formula:

$$J = 1 - F + {\sum }_{q} 〈 {Ψ}_{q}^{( 1 )} \vert {Ψ}_{q}^{( 1 )} 〉$$

Where:
   |q [symbol] is the initial state, where q labels the initial excitation level of the at least two quantum objects,
   |Ψ_{q} [symbol] is the final state when starting in the initial state |q [symbol] ,

$$\vert {Ψ}_{q}^{( 0 )} 〉$$

is the zero order term of the quantum state |Ψ_{q} [symbol] ,

$$\vert {Ψ}_{q}^{( 1 )} 〉$$

is the first order term of the quantum state |Ψ_{q} [symbol] ,
F is the fidelity of the quantum operation given by:

$$F = \frac{1}{16} {\vert 1 + {\sum }_{q ∈ \{ 10 , 01 , 11 \}} {e}^{- i {θ}_{q}} 〈 q \vert {Ψ}_{q}^{( 0 )} 〉 \vert}^{2}$$

the cost function (J) is given by the following formula:

$$J = α ( 1 - F ) + β {\sum }_{q} 〈 {Ψ}_{q}^{( 1 )} \vert {Ψ}_{q}^{( 1 )} 〉$$

Where:
α and β are real positive coefficients,
   |q [symbol] is the initial state, where q labels the initial excitation level of the at least two quantum objects,
   |Ψ_{q} [symbol] is the final state when starting in the initial state |q [symbol] ,

$$\vert {Ψ}_{q}^{( 0 )} 〉$$

is the zero order term of the quantum state |Ψ_{q} [symbol] ,

$$\vert {Ψ}_{q}^{( 1 )} 〉$$

is the first order term of the quantum state |Ψ_{q} [symbol] ,
F is the fidelity of the quantum operation given by:

$$F = \frac{1}{16} {\vert 1 + {\sum }_{q ∈ \{ 10 , 01 , 11 \}} {e}^{- i {θ}_{q}} 〈 q \vert {Ψ}_{q}^{( 0 )} 〉 \vert}^{2}$$

the amplitude robustness criterion states that the optimized pulse is the shortest pulse minimizing the cost function among the pulses minimizing the cost function.

The invention also relates to a method for optimizing a quantum operation to be applied on at least two quantum objects of a system of quantum objects, the method comprising the determination of an optimized pulse to be generated by at least one controlled laser for implementing the quantum operation on the at least two quantum objects while fulfilling a Doppler robustness criterion, the at least two quantum objects having a quantum state depending on the excitation level of the at least two quantum objects, the excitation level being chosen between 01, 10 and 11, 0 defining a de-excited state for a quantum object and 1 defining an excited state for a quantum object, the quantum state having a zero order term and a first order term, the Doppler robustness criterion stating that the optimized pulse is a pulse which when applied on the at least two quantum objects is such that:
the zero order term is substantially of the form e^{iθ}^{_{q}}|q [symbol] , with

$${θ}_{11} - {θ}_{10} - {θ}_{01} = ( 2 n + \frac{1}{2} ) π ,$$

n being an integer,
the first order term for each quantum object is substantially along the direction of |q [symbol] , q being the excitation level of the at least two quantum objects,
the optimized pulse being intended to be generated by the at least one controlled laser and applied on the at least two quantum objects so as to realize the quantum operation.

The method may comprise one or more of the following features considered alone or in any combination that is technically possible:
the at least one controlled laser has a wavevector and each quantum object has a velocity along the direction of the laser propagation, the Doppler shift of each quantum object being the product of the wavevector of the at least one controlled laser and the velocity of said quantum object, the optimized pulse being a pulse formed of two identical halve, the two halves of the optimized pulse being intended to be applied on the quantum objects after each other by the at least one controlled laser so that the sign of the Doppler shift is switched between the two halves;
each half of the optimized pulse is intended to be applied with a different counterpropagating laser;
each half of the optimized pulse is intended to be applied by the same controlled laser, the controlled laser being turned off after the first half and turned back on after a waiting time so as to apply the second half, preferably the waiting time being substantially equal to

$$\frac{π}{{w}_{tr}} ,$$

wₜᵣ being the frequency of the change of the sign of the velocity of the quantum objects in the direction of the laser propagation;
the Doppler robustness criterion states that the optimized pulse is a pulse which minimizes a cost function, the cost function being the sum of a first cost term depending on the zero order term of the quantum state and of a second cost term depending on the first order term of the quantum state.
the cost function is given by the following formula:

$$J = 1 - F + {\sum }_{q , j} 〈 {Ψ}_{q}^{( 1 , j )} ( τ ) \vert I - \vert q 〉 〈 q \vert {Ψ}_{q}^{( 1 , j )} ( τ ) 〉$$

Where:
   |q [symbol] is the initial state, where q labels the initial excitation level of the at least two quantum objects,

$$\vert {Ψ}_{q}^{( 0 )} 〉$$

is the zero order term of the quantum state |Ψ_{q} [symbol] ,

$$\vert {Ψ}_{q}^{( 1 )} 〉$$

is the first order term of the quantum state |Ψ_{q} [symbol] ,
j indexing with respect to the detuning of which one of the at least two quantum objects the expansion is done,
F is the fidelity of the quantum operation given by:

$$F = \frac{1}{16} {\vert 1 + {\sum }_{q ∈ \{ 10 , 01 , 11 \}} {e}^{- i {θ}_{q}} 〈 q \vert {Ψ}_{q}^{( 0 )} 〉 \vert}^{2}$$

I is the identity operator,
τ is the duration of the half of the pulse.
the cost function is given by the following formula:

$$J = α ( 1 - F ) + β {\sum }_{q , j} 〈 {Ψ}_{q}^{( 1 , j )} ( τ ) \vert I - \vert q 〉 〈 q \vert {Ψ}_{q}^{( 1 , j )} ( τ ) 〉$$

α and β are real positive coefficients,
   |q [symbol] is the initial state, where q labels the initial excitation level of the at least two quantum objects,

$$\vert {Ψ}_{q}^{( 0 )} 〉$$

is the zero order term of the quantum state |Ψ_{q} [symbol] ,

$$\vert {Ψ}_{q}^{( 1 )} 〉$$

is the first order term of the quantum state |Ψ_{q} [symbol] ,
j indexing with respect to the detuning of which one of the at least two quantum objects the expansion is done,
F is the fidelity of the quantum operation given by:

$$F = \frac{1}{16} {\vert 1 + {\sum }_{q ∈ \{ 10 , 01 , 11 \}} {e}^{- i {θ}_{q}} 〈 q \vert {Ψ}_{q}^{( 0 )} 〉 \vert}^{2}$$

I is the identity operator,
τ is the duration of the half of the pulse.

The invention also relates to a method for optimizing a quantum operation to be applied on at least two quantum objects of a system of quantum objects, the method comprising the determination of an optimized pulse to be generated by at least one controlled laser for implementing the quantum operation on the at least two quantum objects while fulfilling an amplitude and Doppler robustness criterion, the at least two quantum objects having a quantum state depending on the excitation level of the at least two quantum objects, the excitation level being chosen between 01, 10 and 11, 0 defining a de-excited state for a quantum object and 1 defining an excited state for a quantum object, the quantum state having a zero order term and a first order term, the amplitude and Doppler robustness criterion stating that the optimized pulse is a pulse minimizing a total cost function, the total cost function being the sum of the cost function of the two above methods, preferably the optimized pulse being the shortest pulse minimizing the total cost function among the pulses minimizing the total cost function, the optimized pulse being intended to be generated by the at least one controlled laser and applied on the at least two quantum objects so as to realize the quantum operation.

All of the above methods may comprise one or more of the following features considered alone or in any combination that is technically possible:
the laser pulses minimizing the considered cost function are found using an algorithm assuming that the pulse (Ω(t)) is a piecewise constant pulse of duration T described by N parameters Ω₁, . . . , θ_{N} as Ω(t)=Ωⱼ if t∈

$$∈ [ \frac{( j - 1 ) τ}{N} , \frac{jτ}{N} ] ,$$

j being an integer belonging to the interval [1, . . . , N], the pulse (Ω(t)) minimizing the considered cost function (J) being found by optimizing over the N parameters Ω₁, . . . , Ω_{N} using a gradient descent optimizer.

The invention also relates to a device for optimizing a quantum operation to be applied on two quantum objects of a system of quantum objects, the device comprising a controller configured to implement a method as previously described.

The invention also relates to a method for optimizing a quantum operation to be applied on at least two quantum objects of a system of quantum objects, the method comprising the following steps:
determining an optimized pulse according to a method as previously described,
trapping each of the at least two quantum objects in trapping sites using trapping lasers, the potential of the trapping lasers being modulated in time with a frequency ν so that the potential is periodic in time and quadratic in space, preferably the potential is given by the formula:

$$V ( t , x ) = {V}_{0} ( 1 - cos ( vt ) ) {x}^{2}$$

Where:
V is the potential of a trapping laser,
V₀ is half of the maximal potential of a trapping atom,
ν is the frequency of the modulation,
t is the time, and
x is the position of a quantum object,
generating the determined optimized pulse by the at least one controlled laser and applying the generated optimized pulse on the at least two quantum objects so as to realize the quantum operation.

The invention also relates to a device for optimizing a quantum operation to be applied on at least two quantum objects of a system of quantum objects, the device comprising
a controller configured to determine the optimized pulse of the method as previously described,
trapping lasers configured for trapping each of the at least two quantum objects according to the trapping step of the method as previously described, and
at least one controlled laser configured to generate the determined optimized pulse and to apply the generated optimized pulse on the at least two quantum objects so as to realize the quantum operation.

### BRIEF DESCRIPTION OF THE DRAWINGS

The invention will be easier to understand in view of the following description, provided solely as an example and with reference to the appended drawings in which:

FIG. 1 is a schematic representation of an example of a system of quantum objects and of an entity configured for optimizing a quantum operation to be applied on two quantum objects of a system of quantum objects,

FIG. 2 is an example of a graphic illustrating:
a) Qubits are stored in computational basis states |0 [symbol] and |1 [symbol] . The |1 [symbol] state is coupled to a Rydberg state |r [symbol] with lifetime 1/γ by a laser with Rabi frequency Ω(t). The amplitude of the laser has an unknown relative deviations of ε1 and ε2 and an unknown detuning Δ1 and Δ2 for atom 1 and 2, respectively. The van der Waals interaction leads to an energy shift B>>|Ω| if both atoms are in |r [symbol] , preventing the simultaneous excitation of both atoms.
b) The laser phase as a function of time for the time-optimal (TO) and amplitude-robust (AR) pulse implementing the CZ gate. The amplitude of the pulses is given by |Ω(t)|=Ωmax.

FIG. 3 is an example of a graphic illustrating the Doppler-robust (DR) and amplitude-and-Doppler-robust (ADR) pulse. Each pulse consists of two identical halves. In each of the halves the laser amplitude is maximal (|Ω(t)|=Ωmax), while Ω(t)=0 outside. The laser phase as a function of time is shown on the left vertical axis by the solid line of the top figure the DR pulse and by the solid line of the bottom figure for the ADR pulse. Between the two halves the sign of the detuning kv of an atom due to the Doppler effect is switched, as shown on the right, vertical axis by the dashed line. The reversal of the sign if kv can either be achieved by applying the two halves of the pulses with two different, counterpropagating lasers, or by waiting for half an oscillation of the atom in the trap.

FIG. 4 is an example of a graphic illustrating the modulation of the potential of the optical tweezers trapping the atoms (in solid lines), the velocity of the atoms in the optical tweezers is illustrated in dashed lines. The two halves of the DR and ADR pulses are executed in adjacent time slots marked by the vertical lines. The velocity of the atoms is approximately constant during these time slots and switches signs between adjacent time slots.

FIG. 5 is an example of a graphic illustrating:
a) the infidelity 1−F as a function of ε=ε1=ε2 for the time-optimal (TO), amplitude-robust (AR), Doppler-robust (DR) and amplitude-and-Doppler-robust (ADR) pulse. We assume no errors due to a detuning of the laser (Δ1=Δ2=0) and no error due to the decay of |r [symbol] (γ=0).
b) The infidelity 1−F as a function of the detuning Δ1 of the first atom for the same pulses as in a). We assume that the second atom experiences no detuning (Δ2=0), the laser amplitude is exactly known (ε1=ε2=0) and there is no error due to the decay of |r [symbol] (γ=0).

FIG. 6 is an example of a graphic illustrating the infidelity 1−F of the TO, AR, DR and ADR pulse at different values of the amplitude uncertainty σ_{ε} and the atomic temperature T. In particular, the left curve illustrates 1−F as a function of σ_{ε} at T=0. The right curve illustrates 1−F as a function of T at σ_{ε}=0. Open symbols show the results when switching the laser direction in the middle of the pulse for the DR and ADR pulse, while filled symbols show the results when modulating the trap frequency and waiting half a period of the atomic motion between the two halves of the pulses.

### DETAILED DESCRIPTION OF SOME EMBODIMENTS

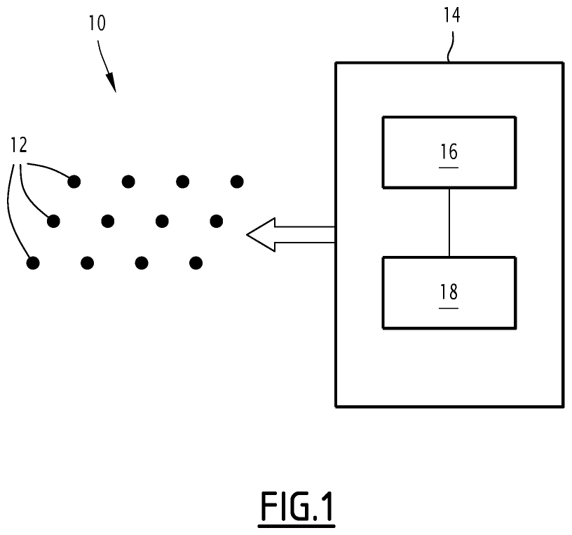

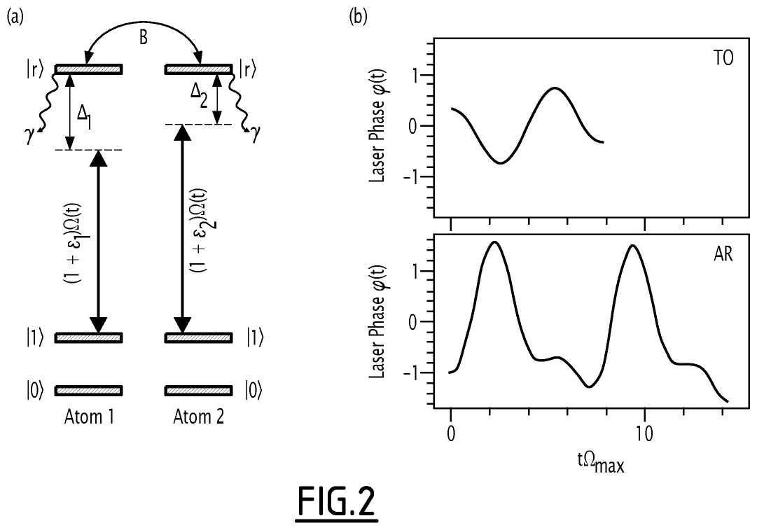

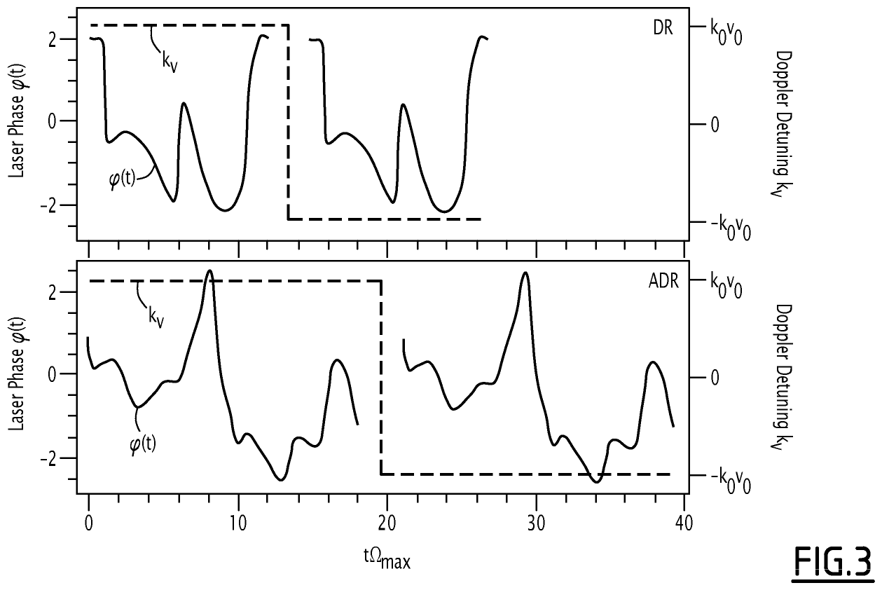

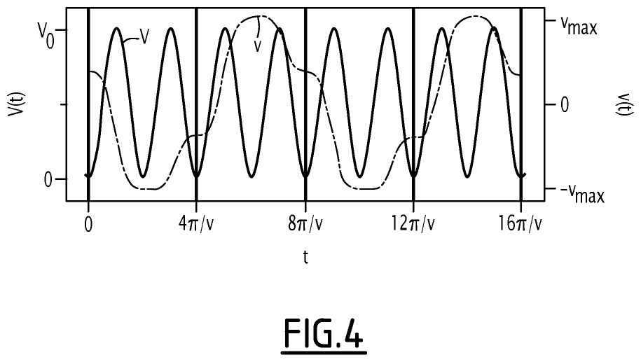

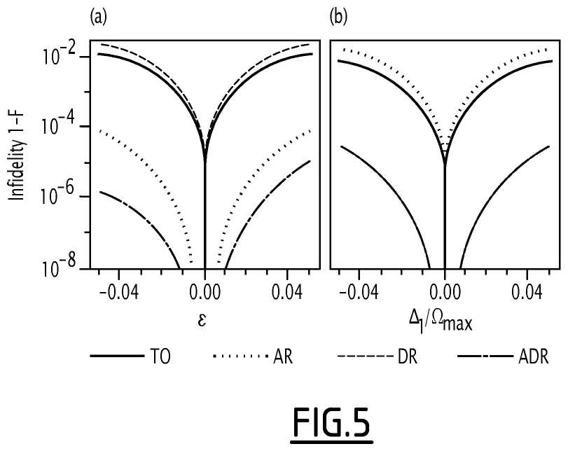

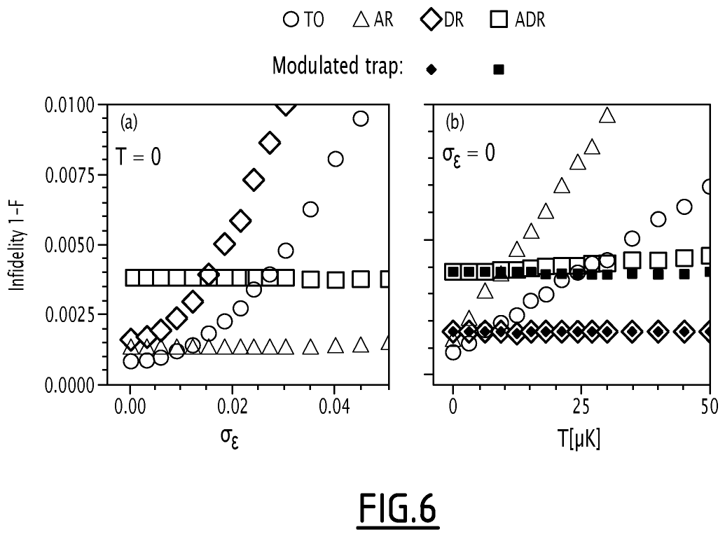

An example of a system 10 of quantum objects 12 and of an entity 14 for optimizing a quantum operation to be applied on two quantum objects 12 of a system of quantum object is illustrated on FIG. 1.

The system 10 of quantum objects 12 are for example intended to be part of one of the following elements: a quantum computer or a quantum sensor.

The quantum objects 12 are objects whose dynamics cannot be described using classical physics, but instead can only accurately be described using the principles of quantum mechanics.

The quantum objects 12 are for example chosen among the following elements: neutral atoms, ions, molecules, quantum dots, spin defects in solids, photons, electrons, superconducting qubits, or any other elements having two or more discrete energy levels that can be coupled to each other and to light.

In the example of the following description, the quantum objects 12 are atoms (trapped ions, neutral atoms) and preferably Rydberg atoms.

The entity 14 enables to optimize a quantum operation to be applied on two quantum objects of a system of quantum objects.

The entity 14 comprises a first device 16 and a second device 18.

The first device 16 comprises a controller configured to carry out method(s) for optimizing a quantum operation to be applied on two quantum objects of a system of quantum objects that will be described in the following of the description. The controller is for example a classical computer having a processor comprising a data processing unit, memories and a data carrier reader, and optionally a human-machine interface.

The second device 18 comprises at least one controlled laser able to generate a laser beam or laser pulses to be applied on the system 10 of quantum objects 12 to realize the quantum operations. The second device 18 is for example controlled by the first device 16 so as to generate laser pulses corresponding to the quantum operations.

The second device 18 comprises for example a signal generator and an optical modulator used to control the amplitude and phase of the light field.

Optionally, the entity 14 also comprises trapping lasers configured for trapping each of the two quantum objects as will be described later in the description.

Methods for optimizing a quantum operation to be applied on two quantum objects of a system of quantum objects will now be described with reference to FIGS. 2 to 6. The method is for example carried out by the entity 14.

In the following, the amplitude of each controlled laser has a first relative deviation ε₁ and a first detuning Δ₁ for the first quantum object and a second relative deviation ε₂ and a second detuning Δ₂ for the second quantum object.

The two quantum objects have a quantum state |ψ_{q} [symbol] depending on the excitation level q of the two quantum objects. The excitation level q is chosen between 01, 10 and 11. 0 defines a de-excited state for a quantum object. 1 defines an excited state for a quantum object. The quantum state |Ψ_{q} [symbol] has a zero order term

$$\vert {Ψ}_{q}^{( 0 )} 〉$$

and a first order term

$$\vert {Ψ}_{q}^{( 0 )} 〉 .$$

The at least one controlled laser has a wavevector k and each quantum object has a velocity vⱼ along the direction of the laser propagation. The Doppler shift Δⱼ of each quantum object is the product of the wavevector k of the at least one controlled laser and the velocity vⱼ of said quantum object.

In particular, with reference to FIG. 2, we give below a specific in the case of Rydberg atoms. This example will then be developed in the following of the description for each considered embodiments.

We assume the level scheme shown in FIG. 2(a). Each atom is modeled as a three level system with computational basis states |0 [symbol] and |1 [symbol] and an auxiliary Rydberg state |r [symbol] with finite lifetime of 1/γ. The |1 [symbol] and |r [symbol] states of each atom are coupled by a single global laser pulse with Rabi frequency Ω(t)=|Ω(t)|e^{iφ(t)} of amplitude |Ω(t)| and phase φ(t). We require that at all times |Ω(t)|≤Ωmax, where Ωmax is the maximally achievable Rabi frequency. Due to shot-to-shot fluctuations of the laser intensity the Rabi frequency at atom i (for i∈{1,2}) is given by (1+εi)Ω(t), where the relative deviation of the laser amplitude εi is unknown but assumed to be constant throughout the gate. Additionally the laser is detuned by an unknown but constant amount Δi from the |1 [symbol] ↔|r [symbol] transition. Finally, an interaction (e.g. a van-der-Waals, dipolar, . . . ) between the two atoms shifts the energy of the state |rr [symbol] by B>>|Ω(t)|, in the Rydberg blockade limit, such that the state |rr [symbol] is never populated. The total Hamiltonian reads H=H10⊕H01⊕H11, with

$${H}_{10} = \frac{( 1 + {ε}_{1} ) Ω ( t )}{2} 10 〉 〈 r0 ∨ + h . c . + {Δ}_{1} r 0 〉 \qquad ( 1 )$$

$${H}_{01} = \frac{( 1 + {ε}_{2} ) Ω ( t )}{2} 01 〉 〈 0 r ∨ + h . c . + {Δ}_{2} 0 r 〉 ─ \qquad ( 2 )$$

$${H}_{11} = \frac{\sqrt{2} ( 1 + {ε}_{+} ) Ω ( t )}{2} \vert 11 〉 〈 {W}_{+} \vert + h . c . + Δ \_ \vert {W}_{+} 〉 〈 W \_ \vert + h . c . + {Δ}_{+} ( \vert {W}_{+} 〉 〈 {W}_{+} \vert + \vert W \_ 〉 〈 W \_ \vert ) \qquad ( 3 )$$

$$Here , {W}_{\pm } 〉 = \frac{[ ( 1 + {ε}_{1} ) r 1 〉 \pm ( 1 + {ε}_{2} ) 1 r 〉 ]}{β}$$

with β=\sqrt{(1+ε₁)²+(1+ε₂)²} the normalization, while

$${Δ}_{\pm } = \frac{{Δ}_{1} \pm {Δ}_{2}}{2} and {ε}_{\frac{+ {ε}_{1} + {ε}_{2}}{2}} ,$$

respectively. In the equation of H₁₁ we neglected terms in second order of ε and Δ.

### First Embodiment: AR Pulse

The method comprises the determination of an optimized pulse to be generated by at least one controlled laser for implementing the quantum operation on the two quantum objects while fulfilling an amplitude robustness criterion.

The optimized pulse for the first embodiment is also called amplitude robust pulse or AR pulse in the description.

The optimized pulse is intended to be generated by the at least one controlled laser and applied on the two quantum objects so as to realize the quantum operation.

The amplitude robustness criterion states that the optimized pulse is a pulse which when applied on the two quantum objects is such that:
the zero order term

$$( \vert {Ψ}_{q}^{( 0 )} 〉 )$$

is substantially of the form e^{iθ}^{_{q}}|q [symbol] , with θ₁₁−θ₁₀−θ₀₁=(2n+1)π, n being an integer, and
the first order term

$$( \vert {Ψ}_{q}^{( 0 )} 〉 )$$

is substantially equal to zero.

In the description, the term substantially means that an error tolerance is taken into account, the error tolerance is for example of 10%.

In an example of implementation, the amplitude robustness criterion states that the optimized pulse is a pulse which minimizes a cost function J. The cost function J is the sum of a first cost term J₁ depending on the zero order term

$$\vert {Ψ}_{q}^{( 0 )} 〉$$

of the quantum state and of a second cost term J₂ depending on the first order term

$$\vert {Ψ}_{q}^{( 1 )} 〉$$

of the quantum state.

Preferably, the cost function J is given by the following formula:

$$J = 1 - F + \sum q 〈 {Ψ}_{q}^{( 1 )} \vert {Ψ}_{q}^{( 1 )} 〉 \qquad ( 4 )$$

Where:
   |q [symbol] is the initial state, where q labels the initial excitation level of the two quantum objects
   |Ψ_{q} [symbol] is the final state when starting in the initial state |q

[symbol]

$$\vert {Ψ}_{q}^{( 0 )} 〉$$

is the zero order term of the quantum state |Ψ_{(q)} [symbol] in a perturbative expansion in the amplitude fluctuation of the laser

$$\vert {Ψ}_{q}^{( 1 )} 〉$$

is the first order term of the quantum state |Ψ_{q} [symbol] in a perturbative expansion in the amplitude fluctuation of the laser
F is the fidelity of the quantum operation given by:

$$F = \frac{1}{16} \vert 1 + \sum {q}_{∈ \{ 10 , 01 , 11 \}} {e}^{- i {θ}_{q}} 〈 q \vert {Ψ}_{q}^{( 0 )} 〉 {\vert}^{2} \qquad ( 5 )$$

The person skilled in the art will understand that such a cost function J can be generalized the following way:

$$J = α ( 1 - F ) + β \sum q 〈 {Ψ}_{q}^{( 1 )} \vert {Ψ}_{q}^{( 1 )} 〉$$

Where: α and β are real positive coefficients (α and β being equal to 1 in the previous example).

Preferably, the amplitude robustness criterion states that the optimized pulse is the shortest pulse minimizing the cost function J among the pulses minimizing the cost function J.

Preferably, the optimized pulse minimizing the considered cost function is found using an algorithm (GRAPE algorithm) assuming that the pulse Ω(t) is a piecewise constant pulse of duration τ described by N parameters Ω₁, . . . , Ω_{N} as Ω(t)=Ωᵢ if

$$t ∈ [ \frac{( j - 1 ) τ}{N} , \frac{j τ}{N} ] ,$$

j being an integer belonging to the interval [1, . . . , N], the pulse Ω(t) minimizing the considered cost function J being found by optimizing over the N parameters Ω₁, . . . , Ω_{N} using a gradient descent optimizer.

The above features will now be described more precisely in the example that follows. We start by finding a pulse Ω(t) which is robust against amplitude deviations εᵢ, while Δᵢ=0. We expand the Hamiltonians in ε as

$${H}_{10} = {H}_{10}^{( 0 )} + {ε}_{1} {H}_{10}^{( 1 )} , {H}_{01} = {H}_{01}^{( 0 )} + {ε}_{2} {H}_{01}^{( 1 )} and {H}_{11} = {H}_{11}^{( 0 )} + {ε}_{+ {H}_{11}^{( 1 )}}$$

and the quantum state when starting in |01 [symbol] as

$$\vert {ψ}_{10} 〉 = \vert {ψ}_{10}^{( 0 )} 〉 + {ϵ}_{1} \vert {ψ}_{10}^{( 1 )} 〉 + O ( {ϵ}_{1}^{2} ) ,$$

with analogous expansions for |ψ₁₀ [symbol] and |ψ₁₁ [symbol] . A pulse Ω(t) of duration τ implements a CZ gate in the deviation-free case if

$$\vert {Ψ}_{q}^{( 0 )} 〉 = {e}^{i {θ}_{q}} \vert q 〉$$

with θ₁₁−θ₁₀−θ₀₁=(2n+1)π for an integer n. We measure the fidelity of a gate via the Bell-State-Fidelity

$$F = \frac{1}{16} {\vert 1 + {\sum }_{q ∈ \{ 10 , 01 , 11 \}} {e}^{- i {θ}_{q}} 〈 q \vert {Ψ}_{q}^{( 0 )} 〉 \vert}^{2}$$

The pulse is robust against amplitude deviations if

$$\vert {Ψ}_{q}^{( 1 )} 〉 = 0$$

for all q, such that the leading term of the deviation of |ψ_{q} [symbol] from e^{iθ}^{_{q}}|q [symbol] is quadratic in εi. To find the robust pulse we minimize the following cost function:

$$J = 1 - F + {\sum }_{q} 〈 {Ψ}_{q}^{( 1 )} \vert {Ψ}_{q}^{( 1 )} 〉$$

using a quantum optimal control method. We choose the numerical GRAPE algorithm (Khaneja N, Reiss T, Kehlet C, Schulte-Herbrüggen T, Glaser S J. Optimal control of coupled spin dynamics: design of NMR pulse sequences by gradient ascent algorithms. J Magn Reson. 2005 February; 172(2):296-30) that assumes that Ω(t) is a piecewise constant pulse of duration τ described by N parameters Ω1, . . . , ΩN as Ω(t)=Ωj if t∈[(j−1)τ/N,jτ/N]. For a given set of parameters the cost function J can be found by solving the coupled differential equations

$$\vert {{\dot{ψ}}_{q}}^{( 0 )} 〉 = - {iH}^{( 0 )} \vert {{ψ}_{q}}^{( 0 )} 〉 and \vert {{\dot{ψ}}_{q}}^{( 1 )} 〉 = - {iH}^{( 0 )} \vert {{ψ}_{q}}^{( 1 )} 〉 - {iH}^{( 1 )} \vert {{ψ}_{q}}^{( 0 )} 〉 .$$

Now the pulse minimizing J can be found by optimizing over the Ω1, . . . , ΩN using a gradient descent optimizer. GRAPE provides an efficient algorithm to calculate the gradient of J with respect to Ωj, drastically speeding up the optimization.

We find that for any pulse duration τ longer than a certain critical τ*=14.32/Ωmax there exists a pulse with J=0, i.e. a pulse that implements a CZ gate with fidelity 1 and is robust against amplitude deviations. We refer to this shortest possible pulse with τ=τ* as the “amplitude-robust” (AR) pulse. The AR pulse is of the form Ω(t)=Ωmax exp(iφ(t)), i.e. it has always maximal amplitude. The laser phase φ(t) of the AR pulse as a function of the dimensionless time tΩmax is shown in FIG. 1(b), together with the time-optimal (TO) pulse (without any robustness) found in S. Jandura and G. Pupillo, Time-Optimal Two- and Three-Qubit Gates for Rydberg Atoms, Quantum 6, 712 (2022). We emphasize that the laser phase of the AR pulse is a smooth function of time, which is easier to implement experimentally than a pulse with discontinuities. In addition to its speed, the AR is interesting also because for τ>τ* the fluctuations of εi during the pulse, an error against which the pulse is not robust, are found to increase.

To demonstrate the robustness of the AR pulse we calculate the infidelity 1−F of the AR and the TO pulse at ε1=ε2=ε for several values of E between −0.05 and 0.05, for γ=0. The infidelities are displayed in FIG. 5(a). For all considered values of ϵ the AR pulse improves upon the TO pulse by at least two orders of magnitude and even for a practically very large amplitude deviation of 5% achieves an infidelity 1−F≈10⁻⁴.

### Second Embodiment: DR Pulse

The method comprises the determination of an optimized pulse to be generated by at least one controlled laser for implementing the quantum operation on the two quantum objects while fulfilling a Doppler robustness criterion.

The optimized pulse for the second embodiment is also called Doppler robust pulse or DR pulse in the description.

The optimized pulse is intended to be generated by the at least one controlled laser and applied on the two quantum objects so as to realize the quantum operation.

The Doppler robustness criterion stating that the optimized pulse is a pulse which when applied on the two quantum objects is such that:
the zero order term

$$( \vert {Ψ}_{q}^{( 0 )} 〉 )$$

is substantially of the form e^{iθ}^{_{q}}|q [symbol] , with

$${θ}_{11} - {θ}_{10} - {θ}_{01} = ( 2 n + \frac{1}{2} ) π ,$$

n being an integer,
the first order term

$$( \vert {Ψ}_{q}^{( 1 , j )} 〉 )$$

for each quantum object is substantially along the direction of |q [symbol] , q being the excitation level of the two quantum objects.

Preferably, the optimized pulse is a pulse formed of two identical halves. The two halves of the optimized pulse is intended to be applied on the quantum objects after each other by the at least one controlled laser so that the sign of the Doppler shift is switched between the two halves.

In an example, each half of the optimized pulse is intended to be applied with a different counterpropagating laser.

In another example, each half of the optimized pulse is intended to be applied by the same controlled laser, the controlled laser being turned off after the first half and turned back on after a waiting time so as to apply the second half, preferably the waiting time being substantially equal to

$$\frac{π}{{w}_{tr}} ,$$

wₜᵣ being the frequency of the change of the sign of the velocity of the quantum objects in the direction of the laser propagation.

In an example of implementation, the Doppler robustness criterion states that the optimized pulse is a pulse which minimizes a cost function J. The cost function J is the sum of a first cost term J₁ depending on the zero order term

$$\vert {Ψ}_{q}^{( 0 )} 〉$$

of the quantum state and of a second cost term J₂ depending on the first order term

$$\vert {Ψ}_{q}^{( 1 )} 〉$$

of the quantum state.

Preferably, the cost function (J) is given by the following formula:

$$J = 1 - F + {\sum }_{q , j} 〈 {Ψ}_{q}^{( 1 , j )} ( τ ) \vert I - \vert q 〉 〈 q \vert {Ψ}_{q}^{( 1 , j )} ( τ ) 〉 \qquad ( 6 )$$

Where:
   |z [symbol] is the initial state, where q labels the initial excitation level of the two quantum objects,

$$\vert {Ψ}_{q}^{( 0 )} 〉$$

is the zero order term of the quantum state |ψ_{q} [symbol] ,

$$\vert {Ψ}_{q}^{( 1 )} 〉$$

is the first order term of the quantum state |ψ_{q} [symbol] ,
j indexing with respect to the detuning of which one of the two quantum objects the expansion is done,
F is the fidelity of the quantum operation given by:

$$F = \frac{1}{16} {\vert 1 + {\sum }_{q ϵ \{ 10 , 01 , 11 \}} {e}^{- i {θ}_{q}} 〈 q \vert {Ψ}_{q}^{( 0 )} 〉 \vert}^{2}$$

I is the identity operator,
τ is the duration of the half of the pulse.

The person skilled in the art will understand that such a cost function J can be generalized the following way:

$$J = α ( 1 - F ) + β {\sum }_{q , j} 〈 {Ψ}_{q}^{( 1 , j )} ( τ ) \vert I - \vert q \text{〉〈} q \vert {Ψ}_{q}^{( 1 , j )} ( τ ) 〉$$

Where: α and β are real positive coefficients (α and β being equal to 1 in the previous example).

Preferably, the optimized pulse minimizing the considered cost function is found using an algorithm (GRAPE algorithm) assuming that the pulse Ω(t) is a piecewise constant pulse of duration τ described by N parameters Ω₁, . . . , Ω_{N} as Ω(t)=Ωᵢ if

$$𝓉 ∈ [ \frac{( j - 1 ) τ}{N} , \frac{j τ}{N} ] ,$$

j being an integer belonging to the interval [1, . . . , N], the pulse Ω(t) minimizing the considered cost function J being found by optimizing over the N parameters Ω₁, . . . , Ω_{N} using a gradient descent optimizer.

The above features will now be described more precisely in the example that follows.

The practically most relevant source of detuning error is the Doppler shift Δj=kvⱼ where k is the wavevector of the laser and vⱼ is the velocity of atom j along the direction of the laser. A robust gate can be achieved by considering pulses which consist of two identical halves which are applied after each other.

The sign of Δj is switched between these two halves, as illustrated in FIG. 3.

We propose two methods for switching the sign of Δj. In the first method two halves are applied with different, counter-propagating lasers, thus switching the sign of k after the first half. The second method makes use of the fact that the trapping potential is approximately harmonic, and therefore the velocity in the direction of the laser propagation is coherent over short times, and periodic with frequency ωₜᵣ. The laser can thus be turned off after the first half and turned back on after a waiting time of π/ωₜᵣ, in which the velocity of the atoms will have switched sign. Only then the second half is applied.

To find a pulse which is robust against Doppler errors we use GRAPE to identify a pulse Ω(t) of duration τ that i) implements a controlled-Rz(π/2) gate in the detuning free case, i.e. satisfies

$$\vert {Ψ}_{q}^{( 0 )} 〉 = {e}^{i {θ}_{q}} \vert q 〉 , with$$

$${θ}_{11} - {θ}_{10} - {θ}_{01} = ( 2 n + \frac{1}{2} ) π ,$$

n being an integer, and ii) has a first order error

$$\vert {Ψ}_{q}^{( 1 , j )} 〉$$

which is completely along the direction of |q [symbol] , i.e. The state after applying this pulse once is then

$$\vert {ψ}_{q} ( τ ) 〉 = ( {e}^{i {θ}_{q}} + {\sum }_{j} {Δ}_{j} 〈 q \vert {ψ}_{q}^{( 1 , j )} ( τ ) 〉 ) \vert q 〉 + O ( {Δ}^{2} ) \qquad ( 7 )$$

When applying the pulse Ω(t) a second time the sign of Δj is switched, so that |ψ_{q}(2τ) [symbol] =e^{2iθ}^{_{q}}|q [symbol] +O(Δ²) so the combined pulse is robust against Doppler errors. Note that crucially the overlap of the state |ψ_{q}(τ) [symbol] with the Rydberg state after the first half is of order O(Δ²).

This makes the gate insensitive to the relative phase of the laser between the two halves, which depends on the unknown position of the atoms. Furthermore it allows to wait for π/ωₜᵣ between the two halves without facing a relevant error due to the decay of the Rydberg state. GRAPE can be applied to this problem analogously to the AR-case, with the cost-function J now containing the norm of instead of the norm of the whole first order contribution

$$\vert {Ψ}_{q}^{( 1 )} 〉$$

for the AR pulse. The shortest possible pulse which is robust against Doppler errors, called the “Doppler-robust” (DR) pulse is shown in FIG. 3. Again the amplitude is given by |Ω(t)|=Ωmax, while the laser phase is a smooth function of time. The pulse Ω(t) has to be applied twice, with the sign of Δj=kvⱼ switching in the middle.

### Third Embodiment: ADR Pulse

The method comprises the determination of an optimized pulse to be generated by at least one controlled laser for implementing the quantum operation on the two quantum objects while fulfilling an amplitude and Doppler robustness criterion.

The optimized pulse for the third embodiment is also called amplitude Doppler robust pulse or ADR pulse in the description.

The optimized pulse is intended to be generated by the at least one controlled laser and applied on the two quantum objects so as to realize the quantum operation.

The amplitude and Doppler robustness criterion states that the optimized pulse is a pulse minimizing a total cost function. The total cost function is the sum of the cost function of the first embodiment (AR pulse) and of the cost function of the second embodiment (DR pulse).

Preferably, the optimized pulse is the shortest pulse minimizing the total cost function among the pulses minimizing the total cost function.

Preferably, the optimized pulse minimizing the considered cost function is found using an algorithm (GRAPE algorithm) assuming that the pulse Ω(t) is a piecewise constant pulse of duration τ described by N parameters Ω₁, . . . , Ω_{N} as Ω(t)=Ωⱼ if

$$𝓉 ∈ [ \frac{( j - 1 ) τ}{N} , \frac{j τ}{N} ] ,$$

j being an integer belonging to the interval [1, . . . , N], the pulse Ω(t) minimizing the considered cost function J being found by optimizing over the N parameters Ω₁, . . . , Ω_{N} using a gradient descent optimizer.

Preferably, the optimized pulse is a pulse formed of two identical halves. The two halves of the optimized pulse is intended to be applied on the quantum objects after each other by the at least one controlled laser so that the sign of the Doppler shift is switched between the two halves.

In an example, each half of the optimized pulse is intended to be applied with a different counterpropagating laser.

In another example, each half of the optimized pulse is intended to be applied by the same controlled laser, the controlled laser being turned off after the first half and turned back on after a waiting time so as to apply the second half, preferably the waiting time being substantially equal to

$$\frac{π}{{w}_{tr}} ,$$

wₜᵣ being the frequency of the change of the sign of the velocity of the quantum objects in the direction of the laser propagation.

The above features will now be described more precisely in the example that follows.

Additionally we identify the shortest possible pulse which is both amplitude- and Doppler robust (ADR). This pulse can be found using GRAPE by simply adding the cost functions for the AR and the DR case. The laser phase of the ADR pulse is displayed in FIG. 3a), while the amplitude is again given by Ωmax.

The infidelity of all four pulses (TO, AR, DR and ADR) as a function of the detuning Δ1 of the first atom is shown in FIG. 5b). For the TO and AR pulse the detuning is kept constant, while for the DR and ADR it switches sign after the first half of the pulse. We observe that the DR and ADR pulse always have very similar infidelities and outperform the TO and AR pulse by two to three orders of magnitude. Even at a large detuning of Δ1=0.05 Ωmax the infidelity is below 10⁻⁴. We also compare the performance of the DR and ADR pulse to the TO and AR pulse when varying the amplitude deviation ϵ in FIG. 5a). As expected the DR pulse does not show any robustness to amplitude deviations and behaves similar to the TO pulse, while the ADR pulse clearly outperforms the TO pulse by at least three orders of magnitude and gives infidelities even below those of the AR pulse.

### Fourth Embodiment: Modulation of Trapping Lasers+DR or ADR Pulse

The method comprises the determination of an optimized pulse, for example a DR pulse using the method of the second embodiment or an ADR pulse using the method of the third embodiment.

According to the fourth embodiment, the two quantum objects are trapped in trapping sites with trapping lasers, the potential of the trapping lasers being modulated in time with a frequency ν so that the potential is periodic in time t and quadratic in space x.

Preferably, the potential is given by the following formula:

$$V ( t , x ) = {V}_{0} ( 1 - cos ( vt ) ) {x}^{2} \qquad ( 8 )$$

Where:
V is the potential of a trapping laser,
V₀ is half of the maximal potential of a trapping atom,
ν is the frequency of the modulation,
t is the time, and
x is the position of a quantum object,

The method also comprises generating the determined optimized pulse by the at least one controlled laser and applying the generated optimized pulse on the two quantum objects so as to realize the quantum operation.

Preferably, the pulses are centered on times when the potential is zero, ie. t=2πn/v, where n is an integer, such that the velocity of the atom is approximately constant over the duration of the pulse and the AC Stark shift of the atomic states is approximately zero over the duration of the pulse.

Preferably, the frequency of the modulation is chosen to be superior to 4 times, approximately equal to 4.079 times the oscillation frequency of the atom in the un-modulated potential:

$$V ( t , x ) = {V}_{0} {x}^{2}$$

such that the atomic velocity at the time of the first pulse, centered on t=2πn/v is nearly exactly opposite the velocity at the time of the second pulse, centered on t=2π (n+4m+2)/v, where n and m are integers, and m≥0.

The modulation frequency can also be approximately 6.046 times the oscillation frequency in the un-modulated potential, such that the atomic velocity at the time of the first pulse, centered on t=2πn/v is nearly exactly opposite the velocity at the time of the second pulse, centered on t=2π(n+6m+3)/v, where n and m are integers, and m≥0.

The modulation frequency can also be chosen to be a larger multiple of the oscillation frequency in the un-modulated potential, such that the atomic velocity is nearly exactly opposite between two times when the instantaneous potential is zero.

The above features will now be described more precisely in the example that follows.

A major error that the DR and the ADR pulse are not robust against is the change of the velocities of the atoms during each of the two subpulses. In the following we provide a method to achieve approximately constant velocities during the pulses, thus reducing the conditional infidelity of the DR and ADR pulses by another one to two orders of magnitude.

We propose to modulate the potential V induced by the optical tweezers trapping the atoms sinusoidally in time with frequency v, so that it is given by

$$V ( t , x ) = {V}_{0} ( 1 - cos ( vt ) ) {x}^{2}$$

The evolution of the atoms in the trap is thus governed by

$$\ddot{x} = \frac{- 2 {V}_{0}}{m} ( 1 - cos ( vt ) ) x ,$$

which is a rescaled version of the Mathieu differential equation. According to Floquets theorem the solutions are of the form x(t)=e^{iω}^{ₜᵣ}^{t}y(t)+c·c. where y is a 2π/v periodic function and 2ωₜᵣ/v is called the Mathieu characteristic exponent. While ωₜᵣ can in general be complex, it has been shown that ωₜᵣ∈R for sufficiently large v. For example, in the limit v→∞ the potential V (t) can be replaced by its time average and we obtain simply ωₜᵣ=\sqrt{2V₀/m}.

We now apply the two subpulses that make up the DR and ADR pulse at times t1=2πn₁/v and t2=2πn₂/v, where n₁ and n₂ are integers. In this way V (t1)=V (t2)=0, so the atoms move with a constant velocity. Since we require v(t1)=−v(t2) the relation (t2−t1)ωtr=π has to be satisfied so that v=2(n₂−n₁)ωₜᵣ.

For a given value of V0 and (n2−n1) we can now numerically find v by first finding the Mathieu characteristic exponent ωₜᵣ. Real solutions for v exist for n2−n1 superior or equal to 2, to ensure that the duration of the time slots with almost constant velocity is as long as possible we take n2−n1=2 and find

$$v = 4.079 \sqrt{\frac{2 {V}_{0}}{m}}$$

The potential V (t) and the exemplary velocity v of an atom moving in this potential are shown in FIG. 6). The two subpulses making up the DR and ADR pulse are to be applied in two adjacent time slots marked by the vertical bars. As can be observed from the figure, the velocity is flat at these time slots, and changes sign between any two adjacent time slots. An additional advantage of the sinusoidal modulation which is not captured in our model is that errors arising from different trapping strengths of different states as well as errors arising from position depending light shifts are minimized because the V is at its minimum during the two subpulses.

For the DR pulse the trap modulation leads to an improvement by approximately one order of magnitude, while for the longer ADR pulse it even leads to an improvement of two orders of magnitude. For both pulses the infidelity at T=30 μK is below 10⁻⁵.

In addition, the modulation of the trap frequencies also increases the robustness against differential light shifts induced by the trapping laser between the computational subspace and the Rydberg state.

### Annex: Infidelities in a Realistic Error Model

So far we have neglected the decay of the Rydberg state and have assumed that the Doppler detuning is constant throughout each half of the pulses while neglecting that the velocity also changes during each half. To account for these effects we now study the performance of the TO, AR, DR and ADR pulse in a more realistic model. For this we assume that the initial velocity and the initial position of the atoms are independent and have a normal distribution with standard deviation

$$\sqrt{\frac{{k}_{B} T}{m}} and \sqrt{\frac{{k}_{B} T}{{{mw}_{tr}}^{2}}}$$

respectively, where T is the temperature of the atoms. We then assume that the atoms follow the classical trajectory in the harmonic oscillator describing the trap and that the Rabi frequency is modified as Ω(t)=e^{-ikx(t)}Ω(t) Furthermore, we assume that ε1=ε2=ε (e.g. because the amplitude deviations arise from amplitude fluctuations of the laser itself and not from position fluctuations of the atoms), and that ε has a normal distribution with standard deviation σₜ. We consider parameters that are experimentally realistic for metastable ¹⁷¹Yb qubits using single-photon excitation to the Rydberg state. The specific numerical values considered are: Ωmax=2π×5.5 MHz, 2π/k=302 nm, 1/γ=100 μs, ωₜᵣ=2π×50 kHz and m=171 u.

The infidelity as a function of σ_{ε} in the T=0 case is shown in FIG. 6 left. For small values of σ_{ε} the decay of the Rydberg state dominates, so that the pulse spending the least time in the Rydberg state has the lowest infidelity. The order of the pulses by increasing time spent in the Rydberg state (in our case identical to increasing pulse duration) is TO, AR, DR, ADR. As σ_{ε} increases the infidelity of the AR and ADR pulses stays almost constant, while the infidelity of the TO and DR pulse increases quadratically. At σ_{ε}≥0.010 the AR pulse becomes favourable compared to the TO pulse, at σ_{ε}≥0.026 the ADR robust pulse becomes favorable compared to the TO pulse. The AR pulse always outperforms the ADR pulse, because both pulses are robust to deviations of the laser amplitude, but the AR pulse spends less time in the Rydberg state.

The infidelity as a function of T in the σ_{ε}=0 case is shown in FIG. 6 right by the open markers. Again at low temperatures the pulses are ordered by the time they spent in the Rydberg state. With increasing temperature the infidelity of the DR and ADR pulse stays almost constant, while the infidelity of the TO and AR pulse increases linearly with T (and thus quadratically with Δ). For T≥6 μK the DR pulse outperforms the TO pulse, for T≥28 μK the ADR pulse outperforms the DR pulse.

Despite being robust against static Doppler shifts, the DR and ADR gate infidelities have a slight linear dependence on the temperature when the harmonic motion of the atoms is incorporated (open symbols in FIG. 6 right). This results from the fact that the atomic velocity is not exactly constant over the finite duration of each half of the pulse, because of the acceleration of the atom from the dipole trap. We find that this can be suppressed by modulating the dipole trap sinusoidally at approximately four times the trap period, centering the pulse halves on the times where the dipole trap intensity is zero, and waiting for half an oscillation period of the atoms between applying the two halves of the pulse. Since the trap intensity is reduced during the gates, the velocity is nearly constant. We analyze this approach further in the fourth embodiment. As seen in by the filled symbols in FIG. 6 right, this eliminates the linear dependence of the fidelity on the temperature for the DR and ADR pulses. We also note that this will strongly suppress light shifts on the Rydberg transition from the dipole trap.

We also study the infidelity (including the trap modulation for the DR and ADR pulse) for the TO, AR, DR and ADR pulse as a function of σ_{ε} and T. As expected the TO pulse is the best pulse for low amplitude uncertainties and low temperatures, while ADR pulse is the best pulse for large amplitude uncertainties and large temperatures. The AR and DR pulses are the best choice when either the amplitude uncertainty or the temperature is large while the other quantity is small. Remarkably the infidelity of the ADR pulse is practically constant for the considered region up to σ_{ε}=0.05 and T=50 μK, taking values between 1−F=0.0038 and 1−F=0.0040.

### Conclusion of the Examples

We have presented three new laser pulses which implement a CZ gate using a global laser and are robust against amplitude deviations of the laser (AR pulse), Doppler shifts (DR pulse) or both error sources (ADR pulse). The pulses were found using the quantum optimal control method GRAPE and require for robustness against Doppler shifts that the sign of the Doppler detuning is switched after the first half of the pulse. Our robust pulses reduce the infidelity arising from amplitude deviations and Doppler shifts by several orders of magnitude at the cost of a larger error due to decay of the Rydberg state. We found the imperfection levels at which the robust pulses outperform the TO pulse and showed that for moderate Temperatures of ≥6 μK or moderate amplitude deviations of ≥1% the TO pulse is outperformed by one of the robust pulses.

Our results show that FTQC on Rydberg atoms can be achieved without cooling the atoms close to the ground state of the traps and without requiring large intensity uniformity of the Rydberg laser. The larger admissible temperature also allows for longer circuits to be executed before heating of the atoms during the computations becomes a limiting factor. The larger tolerance to the laser intensity allows one global laser beam to address more atoms, because also atoms which are not in the center of the beam, where the intensity is maximal, can be addressed. Finally we believe that the end-to-end approach of optimizing quantum gates for logical qubit performance instead of physical gate fidelity may be applied to other qubit platforms.

In addition, it should be noted that the description gave an example with only two quantum objects. However, it can be applied to more quantum objects, for example 3 quantum objects.

In particular, the method applies to any symmetric multi-qubit phase gate. A symmetric multi-qubit phase gate is a gate described by a unitary matrix which is diagonal in the computational basis, and which maps each computational basis state |q> to e^{iθ}^{_{q}}|q>, where the phase θ_{q} depends on the number of qubits which start in state |1> (i.e. the number of 1 in the string q), not on the position of these qubits. Of particular interest are C2Z gates, defined by |111>->−|111> and |q>->|q> for all computational basis states |q> different from |111>. Those gates are relevant as they are, up to single qubit gates, equivalent to a Toffoli gate, which has applications in many quantum algorithms.

Moreover, besides Rydberg atoms, the pulses and the optimization method described in the description could also be applied to other types of particles. For example, they could be applied to qubits stored in polar molecules (see Ni K K, Rosenband T, Grimes D D. Dipolar exchange quantum logic gate with polar molecules. Chem Sci. 2018 Jul. 13; 9(33):6830-6838. doi: 10.1039/c8sc02355g. PMID: 30310615; PMCID: PMC6115616. for the use of polar molecules as qubits). Here, the states |0> and |1> would correspond to different hyperfine states in the rotational and vibrational ground state manifold of each molecule, while the role of the Rydberg state would be played by a rotationally excited state. Furthermore, the person skilled in the art will understand that the GRAPE algorithm is only given in the description as an example of algorithm used to solve the cost function J. However, besides GRAPE, other quantum control algorithms could be used to minimize the cost function J. A very simple approach is to make an Ansatz:

$$Ω ( t ) = {Ω}_{0} \cdot {e}^{i . [ {c}_{1} \cdot {p}_{1} ( t ) + … + {c}_{n} \cdot {p}_{n} ( t ) ]}$$

Where:
Ω₀ is a positive real number, representing the absolute value of the Rabi frequency of the laser used to excite the atoms to the Rydberg state,
p₁(t), . . . , pₙ(t) are some basis functions (e.g. Chebyshev polynomials, Legendre polynomials, Bernstein polynomials or simply sine waves), and
c₁, . . . , cₙ are real coefficients.

A robust pulse can then be found by minimizing the cost function J over the parameters c₁, . . . , cₙ using a gradient descent optimizer or a gradient free optimizer (e.g. BFGS or Nelder-Mead). Besides this approach, a number of quantum optimal control algorithms could be employed, such as Krotov's algorithm (see A. I. Konnov, V. F. Krotov, “On global methods for the successive improvement of control processes”, Avtomat. i Telemekh., 1999, no. 10, 77-88; Autom. Remote Control, 60:10 (1999), 1427-1436) or Chopped random-basis quantum optimization (CRAB) (Caneva, Tommaso et al. “Chopped random-basis quantum optimization.” Physical Review A 84 (2011): 022326.)

1. A method for optimizing a quantum operation to be applied on at least two quantum objects of a system of quantum objects, the method comprising the determination of an optimized pulse to be generated by at least one controlled laser for implementing the quantum operation on the at least two quantum objects while fulfilling an amplitude robustness criterion, the at least two quantum objects having a quantum state depending on the excitation level of the at least two quantum objects, the excitation level being chosen between 01, 10 and 11, 0 defining a de-excited state for a quantum object and 1 defining an excited state for a quantum object, the quantum state having a zero order term and a first order term, the amplitude robustness criterion stating that the optimized pulse is a pulse which when applied on the at least two quantum objects is such that:
the zero order term is substantially of the form e^{iθ}^{_{q}}|q [symbol] , with θ₁₁−θ₁₀−θ₀₁=(2n+1)π, n being an integer,
the first order term is substantially equal to zero,
the optimized pulse being intended to be generated by the at least one controlled laser and applied on the at least two quantum objects so as to realize the quantum operation.

2. A method according to claim 1, wherein the amplitude robustness criterion states that the optimized pulse is a pulse which minimizes a cost function, the cost function being the sum of a first cost term depending on the zero order term of the quantum state and of a second cost term depending on the first order term of the quantum state.

3. A method according to claim 2, wherein the cost function is given by the following formula:
$$J = α ( 1 - F ) + β {\sum }_{q} 〈 {Ψ}_{q}^{( 1 )} \vert {Ψ}_{q}^{( 1 )} 〉$$
where:
α and β are real positive coefficients,

|q [symbol] is the initial state, where q labels the initial excitation level of the at least two quantum objects,

|Ψ_{q} [symbol] is the final state when starting in the initial state |q [symbol] ,
$$\vert {Ψ}_{q}^{( 0 )} 〉$$
is the zero order term of the quantum state |ψ_{q} [symbol] ,
$$\vert {Ψ}_{q}^{( 1 )} 〉$$
is the first order term of the quantum state |Ψ_{q} [symbol] ,
F is the fidelity of the quantum operation given by:
$$F = \frac{1}{16} {\vert 1 + {\sum }_{q ∈ \{ 10 , 01 , 11 \}} {e}^{- i {θ}_{q}} 〈 q \vert {Ψ}_{q}^{( 0 )} 〉 \vert}^{2}$$

4. A method according to claim 2, wherein the amplitude robustness criterion states that the optimized pulse is the shortest pulse minimizing the cost function among the pulses minimizing the cost function.

5. A method for optimizing a quantum operation to be applied on at least two quantum objects of a system of quantum objects, the method comprising the determination of an optimized pulse to be generated by at least one controlled laser for implementing the quantum operation on the at least two quantum objects while fulfilling a Doppler robustness criterion, the at least two quantum objects having a quantum state depending on the excitation level of the at least two quantum objects, the excitation level being chosen between 01, 10 and 11, 0 defining a de-excited state for a quantum object and defining an excited state for a quantum object, the quantum state having a zero order term and a first order term, the Doppler robustness criterion stating that the optimized pulse is a pulse which when applied on the at least two quantum objects is such that:
the zero order term is substantially of the form e^{iθ}^{_{q}}|q [symbol] , with θ₁₁−θ₁₀−
$${θ}_{01} = ( 2 n + \frac{1}{2} ) π ,$$
n being an integer,
the first order term for each quantum object is substantially along the direction of |q [symbol] , q being the excitation level of the at least two quantum objects,
the optimized pulse being intended to be generated by the at least one controlled laser and applied on the at least two quantum objects so as to realize the quantum operation.

6. A method according to claim 5, wherein the at least one controlled laser has a wavevector and each quantum object has a velocity along the direction of the laser propagation, the Doppler shift of each quantum object being the product of the wavevector of the at least one controlled laser and the velocity of said quantum object, the optimized pulse being a pulse formed of two identical halve, the two halves of the optimized pulse being intended to be applied on the quantum objects after each other by the at least one controlled laser so that the sign of the Doppler shift is switched between the two halves.

7. A method according to claim 6, wherein each half of the optimized pulse is intended to be applied with a different counterpropagating laser.

8. A method according to claim 6, wherein each half of the optimized pulse is intended to be applied by the same controlled laser, the controlled laser being turned off after the first half and turned back on after a waiting time so as to apply the second half.

9. A method according to claim 5, wherein the Doppler robustness criterion states that the optimized pulse is a pulse which minimizes a cost function, the cost function being the sum of a first cost term depending on the zero order term of the quantum state and of a second cost term depending on the first order term of the quantum state.

10. A method according to claim 9, wherein the cost function is given by the following formula:
$$J = α ( 1 - F ) + β {\sum }_{q , j} 〈 {Ψ}_{q}^{( 1 , j )} ( τ ) \vert I - \vert q 〉 〈 q \vert {Ψ}_{q}^{( 1 , j )} ( τ ) 〉$$
where:
α and β are real positive coefficients,

|q [symbol] is the initial state, where q labels the initial excitation level of the at least two quantum objects,
$$\vert {Ψ}_{q}^{( 0 )} 〉$$
is the zero order term of the quantum state |Ψ_{q} [symbol] ,
$$\vert {Ψ}_{q}^{( 1 )} 〉$$
is the first order term of the quantum state |Ψ_{q} [symbol] ,
j indexing with respect to the detuning of which one of the at least two quantum objects the expansion is done,
F is the fidelity of the quantum operation given by:
$$F = \frac{1}{16} {\vert 1 + {\sum }_{q ∈ \{ 10 , 01 , 11 \}} {e}^{- i {θ}_{q}} 〈 q \vert {Ψ}_{q}^{( 0 )} 〉 \vert}^{2}$$
I is the identity operator,
τ is the duration of the half of the pulse.

11. A method for optimizing a quantum operation to be applied on at least two quantum objects of a system of quantum objects, the method comprising the determination of an optimized pulse to be generated by at least one controlled laser for implementing the quantum operation on the at least two quantum objects while fulfilling an amplitude and Doppler robustness criterion, the at least two quantum objects having a quantum state depending on the excitation level of the at least two quantum objects, the excitation level being chosen between 01, 10 and 11, 0 defining a de-excited state for a quantum object and 1 defining an excited state for a quantum object, the quantum state having a zero order term and a first order term, the amplitude and Doppler robustness criterion stating that the optimized pulse is a pulse minimizing a total cost function, the total cost function being the sum of a first cost term depending on the zero order term of the quantum state and of a second cost term depending on the first order term of the quantum state and of the cost function being the sum of a first cost term depending on the zero order term of the quantum state and of a second cost term depending on the first order term of the quantum state.

12. A method according to claim 2, wherein the laser pulses minimizing the considered cost function are found using an algorithm assuming that the pulse is a piecewise constant pulse of duration τ described by N parameters Ω₁, . . . , Ω_{N} as Ω(t)=Ωⱼ if t
$$t ∈ [ \frac{( j - 1 ) τ}{N} , \frac{j τ}{N} ] ,$$
j being an integer belonging to the interval [1, . . . , N], the pulse minimizing the considered cost function being found by optimizing over the N parameters Ω₁, . . . , Ω_{N} using a gradient descent optimizer.

13. A device for optimizing a quantum operation to be applied on at least two quantum objects of a system of quantum objects, the device comprising a controller configured to implement a method according to claim 1.

14. A method for optimizing a quantum operation to be applied on at least two quantum objects of a system of quantum objects, the method comprising the following steps:
determining an optimized pulse according to the method of claim 5,
trapping each of the at least two quantum objects in trapping sites using trapping lasers, the potential of the trapping lasers being modulated in time with a frequency v so that the potential is periodic in time and quadratic in space.

15. A device for optimizing a quantum operation to be applied on at least two quantum objects of a system of quantum objects, the device comprising
a controller configured to determine the optimized pulse of the method of claim 14,
trapping lasers configured for trapping each of the at least two quantum objects according to the trapping step of the method of claim 14, and
at least one controlled laser configured to generate the determined optimized pulse and to apply the generated optimized pulse on the at least two quantum objects so as to realize the quantum operation.

16. The method of claim 8, wherein the waiting time is substantially equal to
$$\frac{π}{{w}_{tr}} ,$$
wₜᵣ being the frequency of the change of the sign of the velocity of the quantum objects in the direction of the laser propagation.

17. The method according to claim 11, wherein the optimized pulse is the shortest pulse minimizing the total cost function among the pulses minimizing the total cost function, the optimized pulse being intended to be generated by the at least one controlled laser and applied on the at least two quantum objects so as to realize the quantum operation.

18. A method according to claim 10, wherein the laser pulses minimizing the considered cost function are found using an algorithm assuming that the pulse is a piecewise constant pulse of duration t described by N parameters Ω₁, . . . , Ω_{N} as Ω(t)=Ωⱼ if t
$$t ∈ [ \frac{( j - 1 ) τ}{N} , \frac{j τ}{N} ] ,$$
j being an integer belonging to the interval [1, . . . , N], the pulse minimizing the considered cost function being found by optimizing over the N parameters Ω₁, . . . , Ω_{N} using a gradient descent optimizer.

19. The method according to claim 14, wherein the potential is given by the formula:
$$V ( t , x ) = {V}_{0} ( 1 - cos ( vt ) ) {x}^{2}$$
where:
V is the potential of a trapping laser,
V₀ is half of the maximal potential of a trapping atom,
ν is the frequency of the modulation,
t is the time, and
x is the position of a quantum object,
generating the determined optimized pulse by the at least one controlled laser and applying the generated optimized pulse on the at least two quantum objects so as to realize the quantum operation.
